(19) United States
(12) Patent Application Publication
(10) Pub. No.: US 2004/0196757 A1
(43) Pub. Date: Oct. 7, 2004

(54) Resonance removing apparatus

(76) Inventor: Hsin-Tso Chen, Taipei (TW)

Correspondence Address: Han-Yi Lee, BAYSHORE PATENT GROUP, LLC., 520 Chantecler Dr., Fremont, CA, 94539, US

(21) Appl. No.: 10/827,838

(22) Filed: Apr. 19, 2004

Related U.S. Application Data
(63) Continuation-in-part of application No. 09/900,864, filed on Jul. 10, 2001, now Pat. No. 6,646,977.

(51) Int. Cl. G11B 7/09

(52) U.S. Cl. 369/44.32; 369/139; 369/53.14; 369/53.13

(57) ABSTRACT

A CD-RW resonance removing apparatus comprises a first holding-down plate where at least the driving plate, the sliding rods and the read/write head are mounted; a second holding-down plate to balance the total weight of the first holding-down plate and other components mounted on it; multiple elastic pads attached to the first holding-down plate, called first elastic pads, for connecting the first holding-down plate to the chassis frame; and multiple elastic pads attached to the second holding-down plate, called second elastic pads, connect the second holding-down plate to the first holding-down plate. The first and second elastic pads could be with different K values and damping values. The balancing weight by the second holding-down plate, the absorbing vibration by the second elastic pads, and the isolating vibration function of the first elastic pads, all together, eliminate resonance during operation.

This application is a Continuation-in-Part of Application Ser. No. 09/900,864, filed Jul. 10, 2001, “now Pat. No. 6,646,977”.

### FIELD OF INVENTION

The present invention relates to a resonance removing apparatus, in particular to a resonance removing apparatus for use in a CD-RW drive for removing resonance. The present invention relates to a technology for supporting in a resonance removing manner for disposing the vibration-causing components in a first holding-down plate supported by a multiple elastic pads and a second holding-down plate parallel to the first holding-down plate for providing the weight balance and vibration absorption in order to prevent the resonance of the CD-RW drive.

### BACKGROUND OF THE INVENTION

Optical disc drives, such as CD drives and CD-RW drives, are important devices on PC in which users may store, write or read a large number of data on the optical disc drives comparing to the conventional drives with small capacities.

In addition to the requirement of the read rate, the precision of reading data is required as an indication of the quality assurance of optical disc drive. In the manufacture and production process of the optical disc drives, a most common problem occurs in the vibration of the optical disc drive caused by its driving components while in use. The sources of the vibration may come from the driving motors of the tray, read/write head and the optical disc itself, wherein the rotation driven by the motor to the optical disc is the major source of the vibration. The higher the read/write rate is, the more serious the vibration occurs, which directly reduces the reading precision of the read/write head of the optical disc drives.

### SUMMARY OF THE INVENTION

It is therefore an object of this invention to provide a resonance removing apparatus that is excellent in resonance suppression and removing of a CD-RW drive without causing unnecessary resonance.

Another object of the present invention aims to provide a resonance removing apparatus designed by applying less components and easy structure for segregating the vibrating components and absorbing the resonance of the CD-RW drives in order to suppress the resonance.

The main objective of this invention is to provide a resonance removing apparatus for use in a CD-RW drive for removing resonance. The components that may result in vibration of the CD-RW drive are disposed on a first holding-down plate supported by a multiple elastic pads and a second holding-down plate parallel to the first holding-down plate for providing the weight balance and vibration absorption in order to effectively suppress the resonance of the CD-RW drive.

In order to achieve the above-mentioned objectives, there is provided a resonance removing apparatus for use in CD-RW drive for removing resonance. The CD-RW drive includes a tray, a read/write head, a CD-RW driving plate and other components described in conventional CD-RW drives, which are mounted and arranged in a manner all together on a chassis frame, wherein the tray is controlled by the motor at the front of the chassis frame through a set of gears and a linking component so that the it can move forward and backward on the chassis frame. The read/write head is mounted in the frame-shaped space of the first holding-down plate together with the CD-RW driving plate through two sliding rods. The first holding-down plate connects to the chassis frame through a multiple first elastic pads, while a second holding-down plate is connected and parallel to the first holding-down plate in a manner through a multiple second elastic pads mounted to the second holding-down plate in order to form a resonance removing apparatus.

In the present resonance removing apparatus, the vibration-causing active components are disposed in the first holding-down plate supported by the elastic pads. The second holding-down plate parallel to the first holding-down plate provides weight balance and vibration absorption functions to prevent resonance effectively in order to achieve a more stable rotation driving and a more precise driving signal of the read/write function of the CD-RW drive.

### BRIEF DESCRIPTION OF THE DRAWINGS

FIG. 1 is the plan view showing the resonance removing apparatus of the invention mounted on the CD-RW drive.

FIG. 2 is a perspective view, showing the first and the second holding-down plates of the resonance removing apparatus.

FIG. 3 is an exploded view of the first and the second holding-down plates shown in FIG. 2

FIG. 4 is a cross-sectional view of the first and the second down plates shown in FIG. 2.

### DETAILED DESCRIPTION OF THE PREFERRED EMBODIMENT

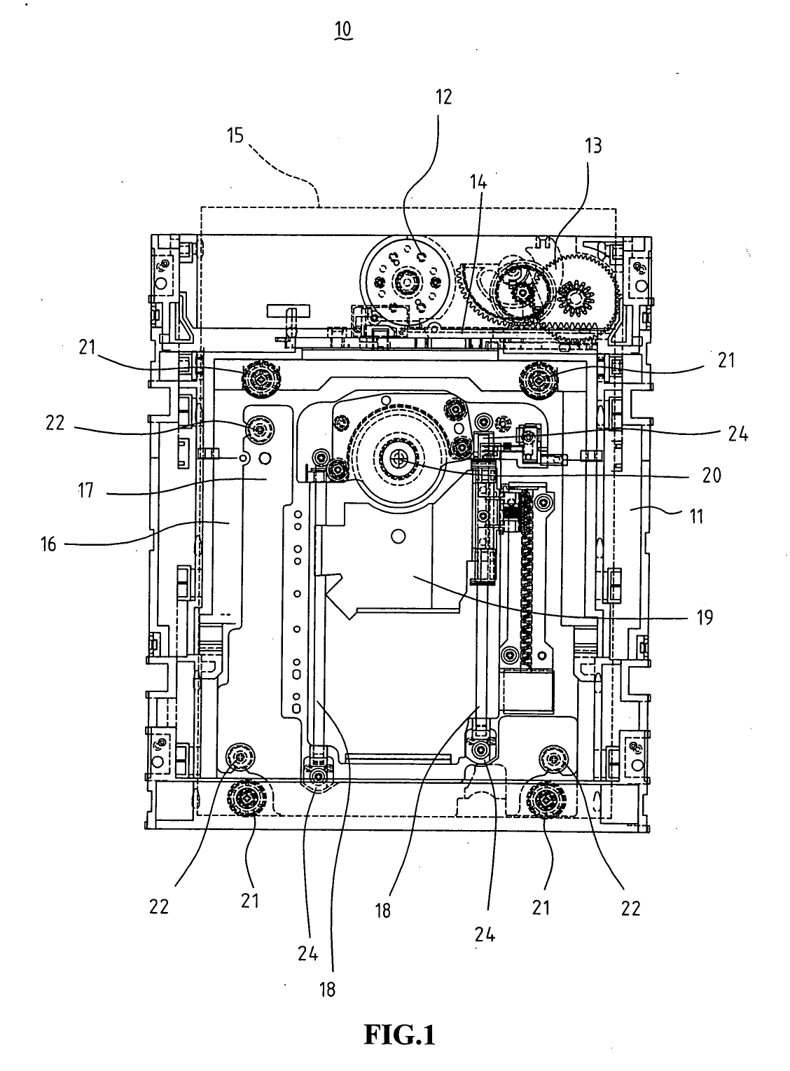

Referring to FIG. 1˜2, the resonance removing apparatus of the present invention is mounted on the CD-RW drive 10. The CD-RW drive 10 includes a tray 15, a read/write head 19, a CD-RW driving plate 20 and other components described in conventional CD-RW drives. These components are mounted and arranged in a manner all together on a chassis frame 11. The tray 15 is controlled by the motor 12 at the front of the chassis frame 11 through a set of gears 13 and a linking component 14 so that the it can move forward and backward on the chassis frame 11 to carry the CD (not shown in the figures). The read/write head 19 and the CD-RW driving plate 20 connect to the chassis frame 11 through the resonance removing apparatus comprising the first holding-down plate 16 and the second holding-down plate 17 for supporting in a vibration proof manner between the CD-RW driving plate 20 and the chassis frame 11.

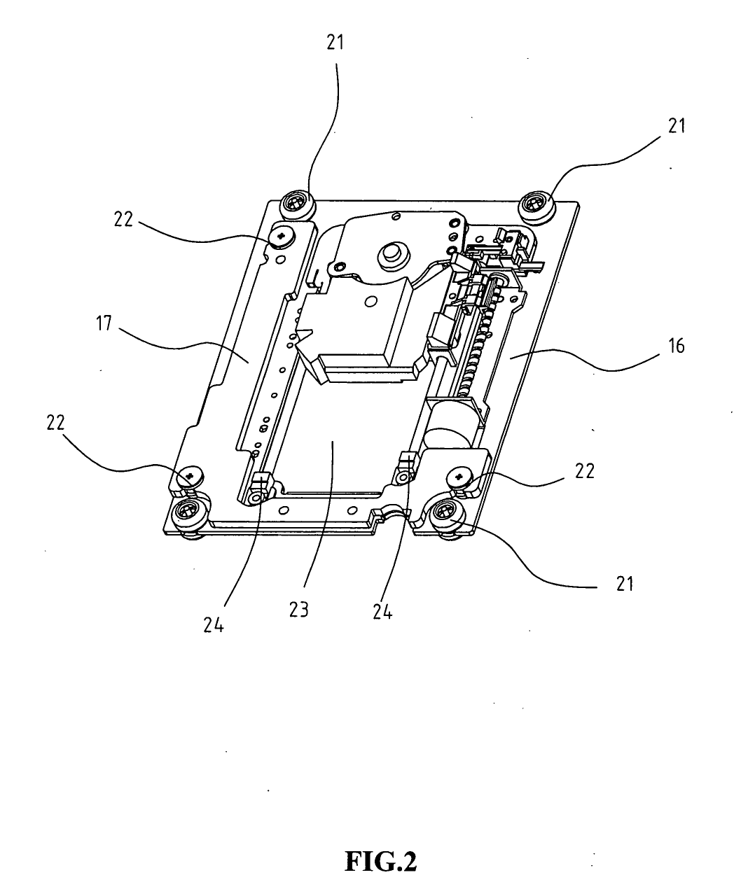

As shown in FIG. 1 and FIG. 2, the read/write head 19 is applied to read or write data from/into the CD. The read/write head 19 is mounted and moved between two sliding rods 18 controlled by the driving motor (figure no shown). The CD-RW driving plate 20 is applied for driving the CD to rotate so that the read/write head 19 can read or write data.

As shown in FIG. 1, the two ends of the two sliding rods 18 in which the read/write head 19 slides in between therein are mounted within the frame-shaped space 23 of the first holding-down plate 16 through a sliding rod seat 24. The CD-RW driving plate 20 is mounted in the same manner within the frame-shaped space 23 of the first holding-down plate.

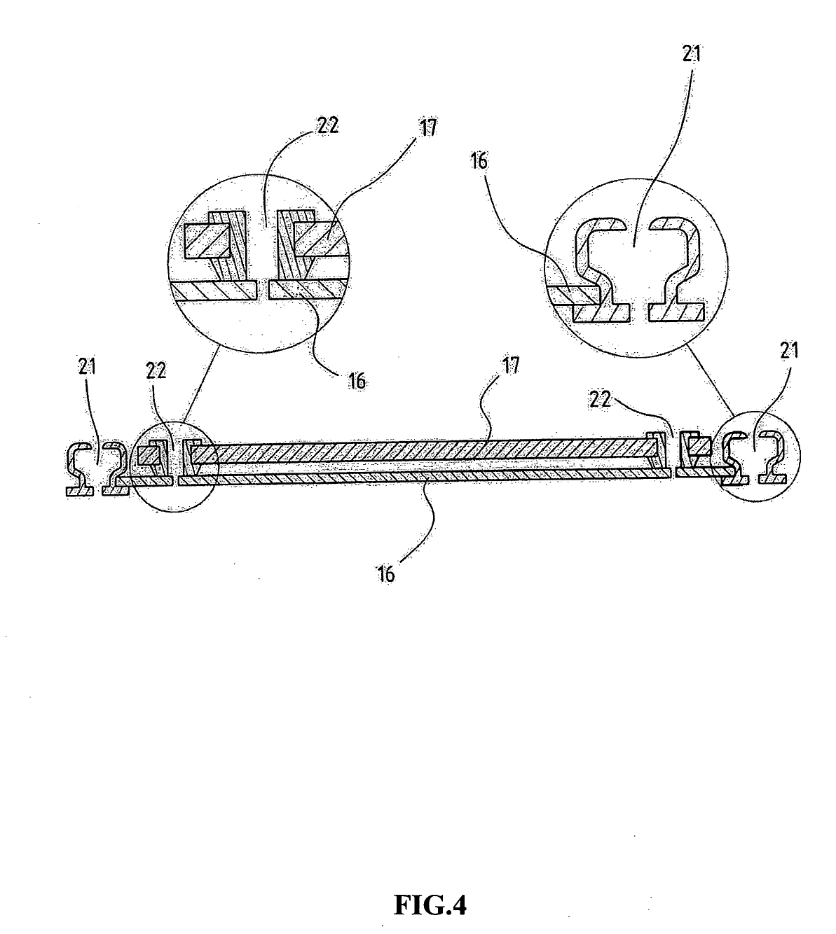

As shown in FIG. 4, the first holding-down plate 16 connects to the chassis frame 11 through a multiple first elastic pads 21 positioned in the two far ends of the first holding-down plate 16. The structure of the multiple the first elastic pads 21 is applied for providing appropriate elasticity between the first holding-down plate 16 and the frame-shaped space 23 and also isolating the vibration effectively.

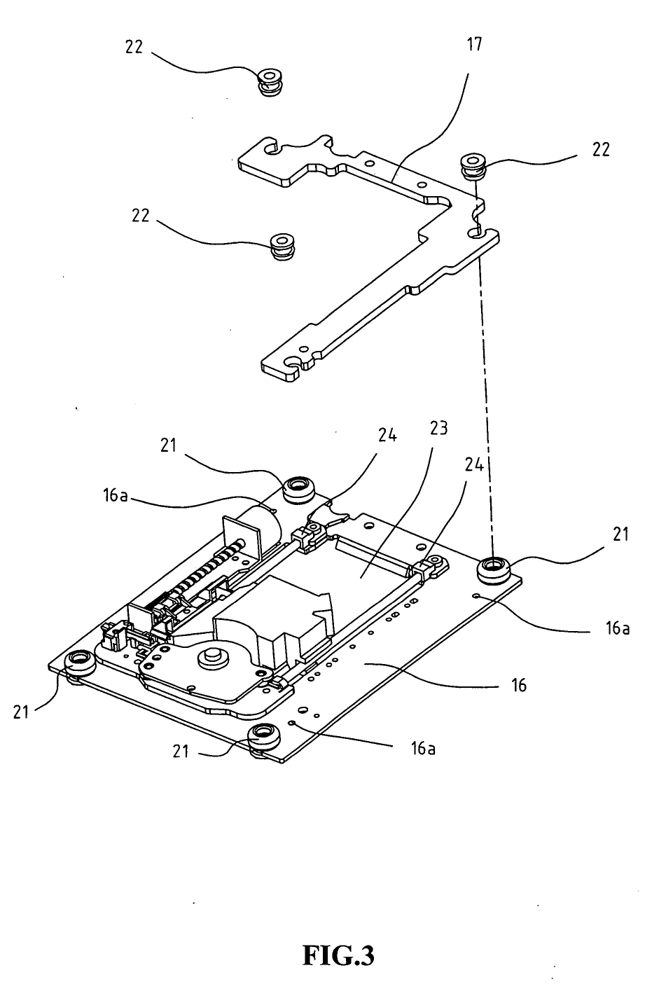

As shown in FIG. 2 and FIG. 3, the shape of the second holding-down plate 17 is about the same as the first holding-down plate 16. As shown in FIG. 4, the second holding-down plate 17 and the first holding-down plate 16 is parallel to each other. The second holding-down plate 17 connects to the first holding-down plate 16 through a multiple the second elastic pads 22. The structure of the multiple the second elastic pads 22 provides appropriate elasticity between the first holding-down plate 16 and the second holding-down plate 17 for absorbing the vibration from the first holding-down plate 16.

In the present resonance removing apparatus, the potential vibration-causing active components, such as CD-RW driving plate 20, are disposed in the first holding-down plate 16 supported by a multiple first elastic pads 21 for isolating the vibration effectively. A second holding-down plate 17 parallel to the first holding-down plate 16 provides the weight balance function for the first holding-down plate 16. The second holding-down plate 17 connects with the first holding-down plate 16 through a multiple the second elastic pads 22. The second holding-down plate 17 does not in contact with the chassis frame 11. Such design can be applied for absorbing the vibration effectively and preventing the vibration of the first holding-down plate 16 from spreading outwards.

The weight balance function of the second holding-down plate 17 is applied for balancing the total weight of the first holding-down plate 16, and other components mounted on the first holding-down plate 16 thereof, such as the read/write head 19 and the CD-RW driving plate 20. In this present invention, the weight balance is considered to be more important than the shape of the second holding down plate 17. Therefore, in our preferred embodiment, the second holding-down plate 17 could be similar in shape of completely different from the first holding-down plate 16.

Therefore, one could perceive that the simple yet elegant design of the present invention of resonance removing apparatus. As shown in the present invention, parts in the CD-RW prone to create vibration are placed on the first holding-down plate 16 supported by elastic pads. Then, the first holding-down plate 16 is laid in parallel to the second holding-down plate 17 which provides weight balance and absorbs vibration. Furthermore, one could choose first elastic pads 21 and second elastic pads 22 with different K values and damping values. The whole assembly and apparatus are very creative and truly innovative.

As shown in FIG. 3, the present invention further comprises, on the first holding-down plate 16, multiple areas 16a to accommodate and fix the second elastic pads 22 to the first holding-down plate 16. By this design, the second holding-down plate 17 can reach the maximum vibration absorption effect.

Many different embodiments of the present invention may be constructed without departing from the spirit and scope of the present invention. It should be understood that the present invention is not limited to the specific embodiments described in this specification. To the contrary, the present invention is intended to cover various modifications and equivalent arrangements included within the spirit and scope of the invention as hereafter claimed. The scope of the following claims is to be accorded the broadest interpretation so as to encompass all such modifications, equivalent structures and functions.

What is claimed is:

1. A CD-RW comprising:
a resonance removing apparatus;
a chassis frame;
a CD-RW driving plate;
a motor at the front of said chassis frame;
a tray moved by a set of gears and a linking component which are propelled by said motor;
two sliding rods connected to said chassis frame; and
a read/write head placed between said sliding rods and connected to said chassis frame by said resonance removing apparatus, slides on said sliding rods.

2. A CD-RW drive as defined in claim 1, wherein said resonance removing apparatus comprising:
a first holding-down plate, where at least said driving plate, said sliding rods and said read/write head are mounted;
a second holding-down plate, to balance the total weight of said first holding-down plate and other components mounted on said first holding-down plate thereof;
multiple elastic pads attached to said first holding-down plate, called first elastic pads, for connecting said first holding-down plate to said chassis frame;
multiple elastic pads attached to said second holding-down plate, called second elastic pads, for connecting said second holding-down plate to said first holding-down plate.
The functions of balancing weight by the second holding-down plate, of absorbing vibration by the second elastic pads, and of isolating vibration by the first elastic pads, all together, eliminate resonance during operation,

3. A CD-RW drive as defined in claim 2, wherein the weight of needed for balancing determines the shape of said second holding-down plate.

4. A CD-RW drive as defined in claim 2, wherein said first and second elastic pads could be with different K values and damping values.

5. A CD-RW drive as defined in claim 2, wherein said first holding-down plate further comprising:
multiple areas to accommodate and fix said second elastic pads to said first holding-down plate for maximum vibration absorption effect.
